(19) United States
(12) Patent Application Publication
(10) Pub. No.: US 2026/0164189 A1
(43) Pub. Date: Jun. 11, 2026

(54) POSTURE-BASED MEDICAL DEVICE OPERATION

(71) Applicant: Cochlear Limited, Macquarie University, NSW (AU)

(72) Inventors: Roger Alan SMITH, St Ives Chase, NSW (AU); Jan Patrick FRIEDING, Grose Vale, NSW (AU)

(21) Appl. No.: 18/706,981

(22) PCT Filed: Oct. 31, 2022
(86) PCT No.: PCT/IB2022/060471

§ 371 Date: May 2, 2024

Related U.S. Application Data
(60) Provisional application No. 63/276,733, filed on Nov. 8, 2021.

(51) Int. Cl. H04R 25/00

(52) U.S. Cl. CPC H04R 25/305; H04R 2460/07

(57) ABSTRACT

Presented herein are techniques for determining and/or changing operation of a medical device, including implantable medical devices and hearing devices, based upon the posture of the recipient of the medical device. For example, when the medical device is embodied as a hearing device, such as a cochlear implant or hearing aid, the directionality of the microphone(s) associated with the hearing device may be set based upon the posture of the recipient of the hearing device.

### BACKGROUND

### Field of the Invention

The present invention relates generally to setting operational characteristics for medical devices, including hearing devices.

### Related Art

Medical devices have provided a wide range of therapeutic benefits to recipients over recent decades. Medical devices can include internal or implantable components/devices, external or wearable components/devices, or combinations thereof (e.g., a device having an external component communicating with an implantable component). Medical devices, such as traditional hearing aids, partially or fully-implantable hearing devices (e.g., bone conduction devices, mechanical stimulators, cochlear implants, etc.), pacemakers, defibrillators, functional electrical stimulation devices, and other medical devices, have been successful in performing lifesaving and/or lifestyle enhancement functions and/or recipient monitoring for a number of years.

The types of medical devices and the ranges of functions performed thereby have increased over the years. For example, many medical devices, sometimes referred to as “implantable medical devices,” now often include one or more instruments, apparatus, sensors, processors, controllers or other functional mechanical or electrical components that are permanently or temporarily implanted in a recipient. These functional devices are typically used to diagnose, prevent, monitor, treat, or manage a disease/injury or symptom thereof, or to investigate, replace or modify the anatomy or a physiological process. Many of these functional devices utilize power and/or data received from external devices that are part of, or operate in conjunction with, implantable components.

### SUMMARY

In one aspect, a first method is provided. The first method comprises: determining a mobility level of a recipient of a hearing device; determining a posture of the recipient of the hearing device; and setting a directionality of the hearing device based upon the posture of the recipient and the mobility level of the recipient.

In another aspect, one or more non-transitory computer readable storage media are provided. The one or more non-transitory computer readable storage media comprise instructions that, when executed by a processor, cause the processor to: determine a change in pitch or roll of a hearing device; determine magnitude of the change in pitch or roll deviates from a predetermined threshold; and set a directionality of the hearing device based upon a deviation of the magnitude of the change in pitch or roll from the predetermined threshold.

In another aspect, a hearing device is provided. The hearing device comprises: one or more inertial sensors; one or more microphones; and one or more processors, wherein the one or more processors are configured to: determine a mobility level of a recipient of the hearing device; determine a posture of the recipient of the hearing device from data received from the one or more inertial sensors; and process audio signals received from the one or more microphones according to a directionality based upon the posture of the recipient and the mobility level of the recipient.

In another aspect, a hearing device is provided. The hearing device comprises: one or more inertial sensors; one or more microphones; and one or more processors, wherein the one or more processors are configured to: determine a mobility level of a recipient of the hearing device, wherein the one or more processors are configured to determine the mobility level of the recipient by determining at least one: the recipient is a pediatric recipient, the recipient is immobile, the recipient crawls, or the recipient walks; determine a posture of the recipient of the hearing device from data received from the one or more inertial sensors, wherein the one or more processors are configured to determine the posture of the recipient of the hearing device by determining a change in pitch or roll of an orientation of the hearing device; and process audio signals received from the one or more microphones according to a directionality based upon the posture of the recipient and the mobility level of the recipient, and wherein one or more inertial sensors comprise one or more of: an accelerometer; an inclinometer; a gyrometer; or a compass.

### BRIEF DESCRIPTION OF THE DRAWINGS

Embodiments of the present invention are described herein in conjunction with the accompanying drawings, in which:

FIG. 1A is a schematic diagram illustrating a cochlear implant system with which aspects of the techniques presented herein can be implemented;

FIG. 1B is a side view of a recipient wearing a sound processing unit of the cochlear implant system of FIG. 1A;

FIG. 1C is a schematic view of components of the cochlear implant system of FIG. 1A;

FIG. 1D is a block diagram of the cochlear implant system of FIG. 1A;

FIGS. 2A and 2B illustrate a comparison of beamforming operation and omnidirectional operation of a hearing device with respect to a pediatric recipient;

FIG. 3 is an illustration of a plurality of hearing device recipient postures and accompanying microphone directionalities;

FIGS. 4A, 4B and 4C illustrate a change in orientation of a hearing device, and in particular, a change in pitch of the hearing device;

FIGS. 5A, 5B and 5C illustrate a change in orientation of a hearing device, and in particular, a change in roll of the hearing device;

FIG. 6 is a flowchart illustrating a first example process for providing hearing device directionality switching according to recipient posture;

FIG. 7 is a flowchart illustrating a second example process for providing hearing device directionality switching according to recipient posture;

FIG. 8 is a flowchart illustrating a third example process for providing hearing device directionality switching according to recipient posture;

FIG. 9 is a functional block diagram of an implantable stimulator system with which aspects of the techniques presented herein can be implemented; and

FIG. 10 is a schematic diagram illustrating a vestibular stimulator system with which aspects of the techniques presented herein can be implemented.

### DETAILED DESCRIPTION

Presented herein are techniques for determining and/or changing operation of a medical device, including implantable medical devices and hearing devices, based upon the posture of the recipient of the medical device. For example, when the medical device is embodied as a hearing device, such as a cochlear implant or hearing aid, the directionality of the microphone(s) associated with the hearing device may be set based upon the posture of the recipient of the hearing device.

The techniques presented herein may be beneficial for a number of different medical device recipients, but pediatric recipients of hearing devices in particular. For example, a pediatric recipient of a hearing device may not be able to face the speaker or may be in a position (e.g. laying down) in which a directional operation of the hearing device microphones is not beneficial or may even be detrimental to providing the best audio signals to the recipient. As a result, some clinicians disable microphone directionality features in hearing devices provided to pediatric recipients due to the fear that the recipient may not be getting the best audio signals when in certain common positions (e.g., when not upright and facing the speaker). Such recipients are therefore not getting the benefits of microphone directionality. As described in detail below, presented herein are techniques that can alleviate these fears, resulting in more clinicians enabling microphone directionality features in hearing devices provided to pediatric recipients. In turn, this will result in more pediatric recipients receiving the benefits of microphone directionality. It is noted that the present disclosure may use terms such as “microphone directionality” or “directionality of the microphone(s).” As understood by the skilled artisan, the “directionality” of a microphone may be a property determined by the processing of audio signals received from the microphone, and may not be indicative of a change in the functioning of a microphone itself. Accordingly, where the present disclosure refers to “microphone directionality” or “directionality of the microphone(s),” it should be broadly construed to include processing of the audio signals in such a way that filters or does not filter certain audio signals received from certain directions or locations relative to the microphone(s).

Merely for ease of description, the techniques presented herein are primarily described with reference to a specific medical device system, namely a cochlear implant system. However, it is to be appreciated that the techniques presented herein may also be partially or fully implemented by other types of implantable and non-implantable medical devices. For example, the techniques presented herein may be implemented by other hearing devices or hearing device systems, such as hearing aids, middle ear auditory prostheses, bone conduction devices, direct acoustic stimulators, electro-acoustic prostheses, auditory brain stimulators, combinations or variations thereof, etc. The techniques presented herein may also be applied to other types of hearing devices, such as consumer grade and commercial grade headphones and earbuds. Accordingly, where the present disclosure refers to a “hearing device” or “hearing devices,” these terms should be broadly construed to include all manner of hearing devices, including but not limited to the above-described hearing devices, including headphones, earbuds and hearing devices with and without external processors. The techniques presented herein may also be implemented by dedicated tinnitus therapy devices and tinnitus therapy device systems. In further embodiments, the presented herein may also be implemented by, or used in conjunction with, vestibular devices (e.g., vestibular implants), visual devices (i.e., bionic eyes), sensors, pacemakers, drug delivery systems, defibrillators, functional electrical stimulation devices, catheters, seizure devices (e.g., devices for monitoring and/or treating epileptic events), sleep apnea devices, electroporation devices, etc.

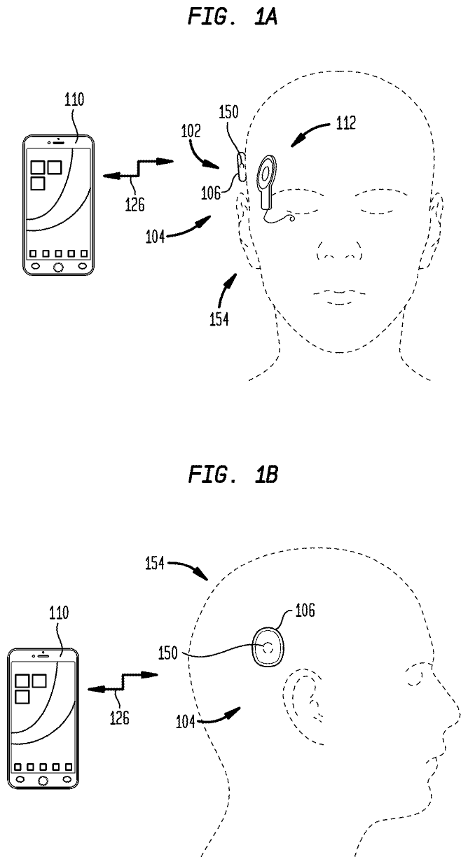

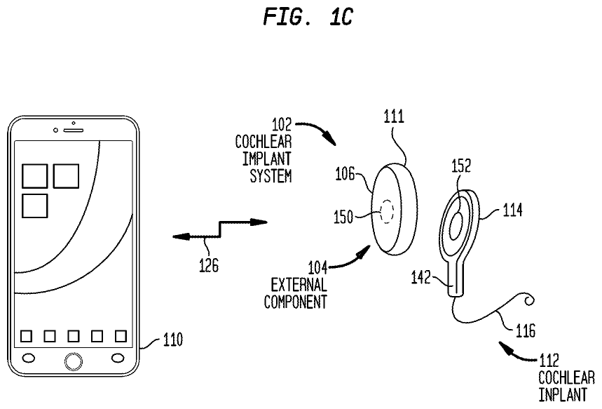

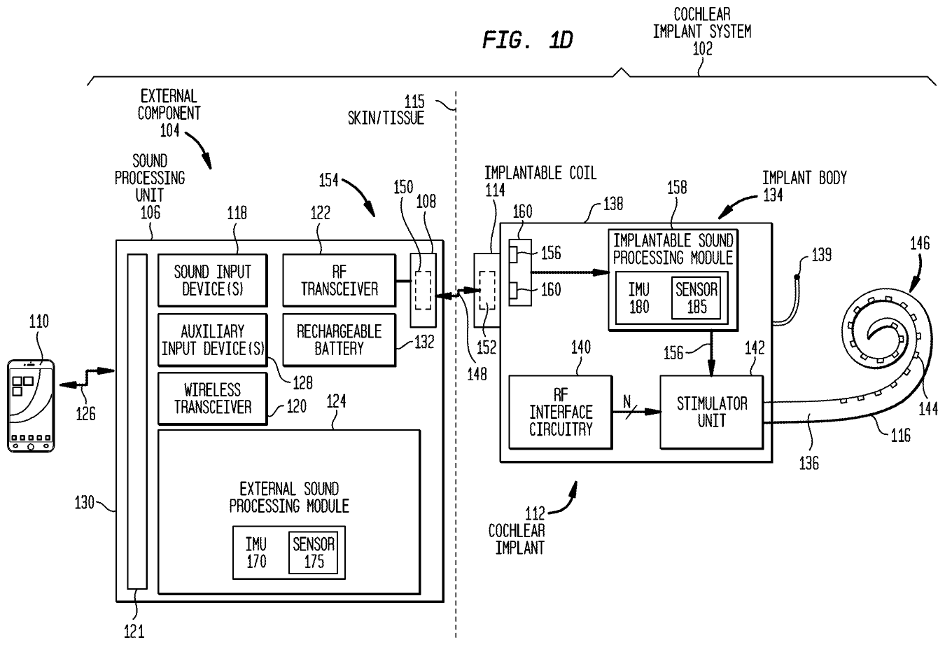

FIGS. 1A-1D illustrates an example cochlear implant system 102 with which aspects of the techniques presented herein can be implemented. The cochlear implant system 102 comprises an external component 104 and an implantable component 112. In the examples of FIGS. 1A-1D, the implantable component is sometimes referred to as a “cochlear implant.” FIG. 1A illustrates the cochlear implant 112 implanted in the head 154 of a recipient, while FIG. 1B is a schematic drawing of the external component 104 worn on the head 154 of the recipient. FIG. 1C is another schematic view of the cochlear implant system 102, while FIG. 1D illustrates further details of the cochlear implant system 102. For ease of description, FIGS. 1A-1D will generally be described together.

Cochlear implant system 102 includes an external component 104 that is configured to be directly or indirectly attached to the body of the recipient and an implantable component 112 configured to be implanted in the recipient. In the examples of FIGS. 1A-1D, the external component 104 comprises a sound processing unit 106, while the cochlear implant 112 includes an implantable coil 114, an implant body 134, and an elongate stimulating assembly 116 configured to be implanted in the recipient's cochlea.

In the example of FIGS. 1A-1D, the sound processing unit 106 is an off-the-ear (OTE) sound processing unit, sometimes referred to herein as an OTE component, that is configured to send data and power to the implantable component 112. In general, an OTE sound processing unit is a component having a generally cylindrically shaped housing 111 and which is configured to be magnetically coupled to the recipient's head (e.g., includes an integrated external magnet 150 configured to be magnetically coupled to an implantable magnet 152 in the implantable component 112). The OTE sound processing unit 106 also includes an integrated external (headpiece) coil 108 that is configured to be inductively coupled to the implantable coil 114.

It is to be appreciated that the OTE sound processing unit 106 is merely illustrative of the external devices that could operate with implantable component 112. For example, in alternative examples, the external component may comprise a behind-the-ear (BTE) sound processing unit or a micro-BTE sound processing unit and a separate external. In general, a BTE sound processing unit comprises a housing that is shaped to be worn on the outer ear of the recipient and is connected to the separate external coil assembly via a cable, where the external coil assembly is configured to be magnetically and inductively coupled to the implantable coil 114. It is also to be appreciated that alternative external components could be located in the recipient's ear canal, worn on the body, etc.

As noted above, the cochlear implant system 102 includes the sound processing unit 106 and the cochlear implant 112. However, as described further below, the cochlear implant 112 can operate independently from the sound processing unit 106, for at least a period, to stimulate the recipient. For example, the cochlear implant 112 can operate in a first general mode, sometimes referred to as an “external hearing mode,” in which the sound processing unit 106 captures sound signals which are then used as the basis for delivering stimulation signals to the recipient. The cochlear implant 112 can also operate in a second general mode, sometimes referred as an “invisible hearing” mode, in which the sound processing unit 106 is unable to provide sound signals to the cochlear implant 112 (e.g., the sound processing unit 106 is not present, the sound processing unit 106 is powered-off, the sound processing unit 106 is malfunctioning, etc.). As such, in the invisible hearing mode, the cochlear implant 112 captures sound signals itself via implantable sound sensors and then uses those sound signals as the basis for delivering stimulation signals to the recipient. Further details regarding operation of the cochlear implant 112 in the external hearing mode are provided below, followed by details regarding operation of the cochlear implant 112 in the invisible hearing mode. It is to be appreciated that reference to the external hearing mode and the invisible hearing mode is merely illustrative and that the cochlear implant 112 could also operate in alternative modes.

In FIGS. 1A and 1C, the cochlear implant system 102 is shown with an external device 110, configured to implement aspects of the techniques presented. The external device 110 is a computing device, such as a computer (e.g., laptop, desktop, tablet), a mobile phone, remote control unit, etc. As described further below, the external device 110 comprises a telephone enhancement module that, as described further below, is configured to implement aspects of the auditory rehabilitation techniques presented herein for independent telephone usage. The external device 110 and the cochlear implant system 102 (e.g., OTE sound processing unit 106 or the cochlear implant 112) wirelessly communicate via a bi-directional communication link 126 and interface 121. The bi-directional communication link 126 may comprise, for example, a short-range communication, such as Bluetooth link, Bluetooth Low Energy (BLE) link, a proprietary link, etc.

Returning to the example of FIGS. 1A-1D, the OTE sound processing unit 106 comprises one or more input devices that are configured to receive input signals (e.g., sound or data signals). The one or more input devices include one or more sound input devices 118 (e.g., one or more external microphones, audio input ports, telecoils, etc.).

According to the techniques of the present disclosure, sound input devices 118 may include two or more microphones or at least one directional microphone. Through such microphones, directionality of the microphones may be optimized, such as optimization on a horizontal plane defined by the microphones. Accordingly, classic beamformer design may be used for optimization around a polar plot corresponding to the horizontal plane defined by the microphone(s).

Also included in the sound processing unit 106 are one or more auxiliary input devices 128 (e.g., audio ports, such as a Direct Audio Input (DAI), data ports, such as a Universal Serial Bus (USB) port, cable port, etc.), and a wireless transmitter/receiver (transceiver) 120 (e.g., for communication with the external device 110). However, it is to be appreciated that one or more input devices may include additional types of input devices and/or less input devices (e.g., the wireless short range radio transceiver 120 and/or one or more auxiliary input devices 128 could be omitted).

The OTE sound processing unit 106 also comprises the external coil 108, a charging coil 130, a closely-coupled transmitter/receiver (RF transceiver) 122, sometimes referred to as or radio-frequency (RF) transceiver 122, at least one rechargeable battery 132, and an external sound processing module 124. The external sound processing module 124 may comprise, for example, one or more processors and a memory device (memory) that includes sound processing logic. The memory device may comprise any one or more of: Non-Volatile Memory (NVM), Ferroelectric Random Access Memory (FRAM), read only memory (ROM), random access memory (RAM), magnetic disk storage media devices, optical storage media devices, flash memory devices, electrical, optical, or other physical/tangible memory storage devices. The one or more processors are, for example, microprocessors or microcontrollers that execute instructions for the sound processing logic stored in memory device.

The implantable component 112 comprises an implant body (main module) 134, a lead region 136, and the intra-cochlear stimulating assembly 116, all configured to be implanted under the skin/tissue (tissue) 115 of the recipient. The implant body 134 generally comprises a hermetically-sealed housing 138 in which RF interface circuitry 140 and a stimulator unit 142 are disposed. The implant body 134 also includes the internal/implantable coil 114 that is generally external to the housing 138, but which is connected to the RF interface circuitry 140 via a hermetic feedthrough (not shown in FIG. 1D).

As noted, stimulating assembly 116 is configured to be at least partially implanted in the recipient's cochlea. Stimulating assembly 116 includes a plurality of longitudinally spaced intra-cochlear electrical stimulating contacts (electrodes) 144 that collectively form a contact or electrode array 146 for delivery of electrical stimulation (current) to the recipient's cochlea.

Stimulating assembly 116 extends through an opening in the recipient's cochlea (e.g., cochleostomy, the round window, etc.) and has a proximal end connected to stimulator unit 142 via lead region 136 and a hermetic feedthrough (not shown in FIG. 1D). Lead region 136 includes a plurality of conductors (wires) that electrically couple the electrodes 144 to the stimulator unit 142. The implantable component 112 also includes an electrode outside of the cochlea, sometimes referred to as the extra-cochlear electrode (ECE) 139.

As noted, the cochlear implant system 102 includes the external coil 108 and the implantable coil 114. The external magnet 152 is fixed relative to the external coil 108 and the implantable magnet 152 is fixed relative to the implantable coil 114. The magnets fixed relative to the external coil 108 and the implantable coil 114 facilitate the operational alignment of the external coil 108 with the implantable coil 114. This operational alignment of the coils enables the external component 104 to transmit data and power to the implantable component 112 via a closely-coupled wireless link 148 formed between the external coil 108 with the implantable coil 114. In certain examples, the closely-coupled wireless link 148 is a radio frequency (RF) link. However, various other types of energy transfer, such as infrared (IR), electromagnetic, capacitive and inductive transfer, may be used to transfer the power and/or data from an external component to an implantable component and, as such, FIG. 1D illustrates only one example arrangement.

As noted above, sound processing unit 106 includes the external sound processing module 124. The external sound processing module 124 is configured to convert received input signals (received at one or more of the input devices) into output signals for use in stimulating a first ear of a recipient (i.e., the external sound processing module 124 is configured to perform sound processing on input signals received at the sound processing unit 106). Stated differently, the one or more processors in the external sound processing module 124 are configured to execute sound processing logic in memory to convert the received input signals into output signals that represent electrical stimulation for delivery to the recipient.

As noted, FIG. 1D illustrates an embodiment in which the external sound processing module 124 in the sound processing unit 106 generates the output signals. In an alternative embodiment, the sound processing unit 106 can send less processed information (e.g., audio data) to the implantable component 112 and the sound processing operations (e.g., conversion of sounds to output signals) can be performed by a processor within the implantable component 112.

Returning to the specific example of FIG. 1D, the output signals are provided to the RF transceiver 122, which transcutaneously transfers the output signals (e.g., in an encoded manner) to the implantable component 112 via external coil 108 and implantable coil 114. That is, the output signals are received at the RF interface circuitry 140 via implantable coil 114 and provided to the stimulator unit 142. The stimulator unit 142 is configured to utilize the output signals to generate electrical stimulation signals (e.g., current signals) for delivery to the recipient's cochlea. In this way, cochlear implant system 102 electrically stimulates the recipient's auditory nerve cells, bypassing absent or defective hair cells that normally transduce acoustic vibrations into neural activity, in a manner that causes the recipient to perceive one or more components of the received sound signals.

As detailed above, in the external hearing mode the cochlear implant 112 receives processed sound signals from the sound processing unit 106. However, in the invisible hearing mode, the cochlear implant 112 is configured to capture and process sound signals for use in electrically stimulating the recipient's auditory nerve cells. In particular, as shown in FIG. 1D, the cochlear implant 112 includes a plurality of implantable sound sensors 160 and an implantable sound processing module 158. Similar to the external sound processing module 124, the implantable sound processing module 158 may comprise, for example, one or more processors and a memory device (memory) that includes sound processing logic. The memory device may comprise any one or more of: Non-Volatile Memory (NVM), Ferroelectric Random Access Memory (FRAM), read only memory (ROM), random access memory (RAM), magnetic disk storage media devices, optical storage media devices, flash memory devices, electrical, optical, or other physical/tangible memory storage devices. The one or more processors are, for example, microprocessors or microcontrollers that execute instructions for the sound processing logic stored in memory device.

According to the techniques of the present disclosure, external sound processing module 124 may include an inertial measurement unit (IMU) 170. The inertial measurement unit 170 is configured to measure the inertia of the recipient's head, that is, motion of the recipient's head. As such, inertial measurement unit 170 comprises one or more sensors 175 each configured to sense one or more of rectilinear or rotatory motion in the same or different axes. Examples of sensors 175 that may be used as part of inertial measurement unit 170 include accelerometers, gyroscopes, inclinometers, compasses, and the like. Such sensors may be implemented in, for example, micro electromechanical systems (MEMS) or with other technology suitable for the particular application.

The inertial measurement unit 170 may be disposed in the external sound processing module 124, which forms part of external component 104, which is in turn configured to be directly or indirectly attached to the body of a recipient. The attachment of the inertial measurement unit 170 to the recipient has sufficient firmness, rigidity, consistency, durability, etc. to ensure that the accuracy of output from the inertial measurement unit 170 is sufficient for use in the systems and methods described herein. For instance, the looseness of the attachment should not lead to a significant number of instances in which head movement that is consistent with a change in posture (as described below) is not identified as such nor a significant number of instances in which head movement that is inconsistent with a change in posture is not identified as such. In the absence of such an attachment, the inertial measurement unit 170 must accurately reflect the recipient's head movement using other techniques.

For completeness, it is noted that external sound processing module 124 may be embodied as a BTE sound processing module or an OTE sound processing module. Accordingly, the techniques of the present disclosure are applicable to both BTE and OTE hearing devices.

The data collected by the sensors 175 is sometimes referred to herein as head motion data. As described further below, the head motion data may be utilized by external sound processing module 124 to alter an operating parameter of sound sensor 160.

As also illustrated in FIG. 1D, a second inertial measurement unit 180 including sensors 185 is incorporated into implantable sound processing module 158 of implant body 134. Second inertial measurement unit 180 may serve as an additional or alternative inertial measurement unit to inertial measurement unit 170 of external sound processing module 124. Like sensors 175, sensors 185 may each be configured to sense one or more of rectilinear or rotatory motion in the same or different axes. Examples of sensors 185 that may be used as part of inertial measurement unit 180 include accelerometers, gyroscopes, inclinometers, compasses, and the like. Such sensors may be implemented in, for example, micro electromechanical systems (MEMS) or with other technology suitable for the particular application.

For hearing devices that include an implantable sound processing module, such as implantable sound processing module 158, that includes an IMU, such as IMU 180, the techniques presented herein may be implemented without an external processor. Accordingly, a hearing device that includes an implant body 134 and lacks an external component 104 may be configured to implement the techniques presented herein.

In the invisible hearing mode, the implantable sound sensors 160 are configured to detect/capture signals (e.g., acoustic sound signals, vibrations, etc.), which are provided to the implantable sound processing module 158. The implantable sound processing module 158 is configured to convert received input signals (received at one or more of the implantable sound sensors 160) into output signals for use in stimulating the first ear of a recipient (i.e., the processing module 158 is configured to perform sound processing operations). Stated differently, the one or more processors in implantable sound processing module 158 are configured to execute sound processing logic in memory to convert the received input signals into output signals 156 that are provided to the stimulator unit 142. The stimulator unit 142 is configured to utilize the output signals 156 to generate electrical stimulation signals (e.g., current signals) for delivery to the recipient's cochlea, thereby bypassing the absent or defective hair cells that normally transduce acoustic vibrations into neural activity.

It is to be appreciated that the above description of the so-called external hearing mode and the so-called invisible hearing mode are merely illustrative and that the cochlear implant system 102 could operate differently in different embodiments. For example, in one alternative implementation of the external hearing mode, the cochlear implant 112 could use signals captured by the sound input devices 118 and the implantable sound sensors 160 in generating stimulation signals for delivery to the recipient.

As noted above, implantable medical devices, such as cochlear implant system 102 of FIG. 1D, may include microphones that operate according to operational parameters that allow the microphones to operate with directionality to improve signal-to-noise ratio (“SNR”) of the processed audio signals. This microphone directionality allows recipients to have, for example, improved speech recognition in noisy situations. These microphone directionality techniques rely on the user facing the speaker so the directional microphones may pick up the speaker's voice and block out noise to the sides and rear of listener.

Some recipients of hearing devices, such as pediatric recipients of cochlear implant devices, may not be able to face the speaker or may be in a position that means directionality is not beneficial, and may even be detrimental, to receiving the best SNR. An example of such a position may be a prone position (i.e., lying face down) or a supine position (i.e., laying face up). For example, a prone or supine pediatric recipient may not be facing the source of a particular audio signal, and therefore, using microphone directionality may not be beneficial for such a recipient.

For example, in the case of a pediatric recipient of a cochlear implant system laying in a bed, operating a microphone with directionality oriented in the direction in which the recipient is facing may not be appropriate to detect audio signals coming from a parent or caregiver in the same room. More specifically, a prone or supine recipient may be facing the floor or ceiling of a room, respectively, directed away from where the source of a detected audio signal is unlikely to originate. Therefore, operating a microphone with directionality based on where the recipient is facing would be inappropriate or possibly detrimental to optimal processing of received audio signals when the recipient is in such positions. For example, basing the directionality of such a pediatric recipient's microphone on where the recipient is facing could result in the desired audio signals being filtered out due to the directionality of the microphone operation.

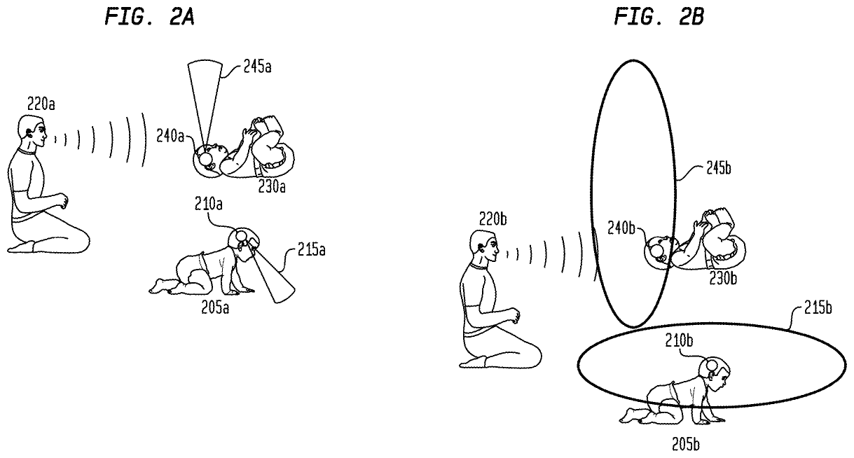

For example, illustrated in FIG. 2A is a crawling pediatric recipient 205a who is facing downward and away from sound source 220a. Because pediatric recipient 205a has limited mobility, it may not be able to easily or quickly turn and face sound source 220a. The hearing device 210a is nevertheless operating with beamformed directionality 215a. Accordingly, hearing device 210a may filter out sound source 220a. On the other hand, as illustrated in FIG. 2B, hearing device 210b of crawling pediatric recipient 205b may be operating with omnidirectional directionality 215b (i.e., “omnidirectionality”). Accordingly, hearing device 210b will not filter out audio source 220b, and will instead provide audio signals associated with audio source 220b to recipient 205b.

Similarly, supine pediatric recipient 230a of FIG. 2A is facing upwards toward the ceiling. The hearing device 240a is nevertheless operating with beamformed directionality 245a. Accordingly, hearing device 240a may filter out sound source 220a. On the other hand, as illustrated in FIG. 2B, hearing device 240b of supine pediatric recipient 230b may be operating with omnidirectional directionality 245b. Accordingly, hearing device 240b will not filter out audio source 220b, and will instead provide audio signals associated with audio source 220b to recipient 230b.

Accordingly, not all clinicians utilize microphone directionality for pediatric recipients in fear that the recipient may not be getting the best SNR when in certain common positions, such as when the recipient is not upright and/or otherwise not facing a speaker. As a result, when the recipient is positioned where directionality is beneficial but not enabled, e.g., when the recipient is facing the speaker, the recipient is not getting the benefits of microphone directionality. When clinicians decide to not use microphone directionality, recipients may receive audio with unnecessarily low SNR, and recipients may be paying for features (e.g., microphone directionality) that are never utilized.

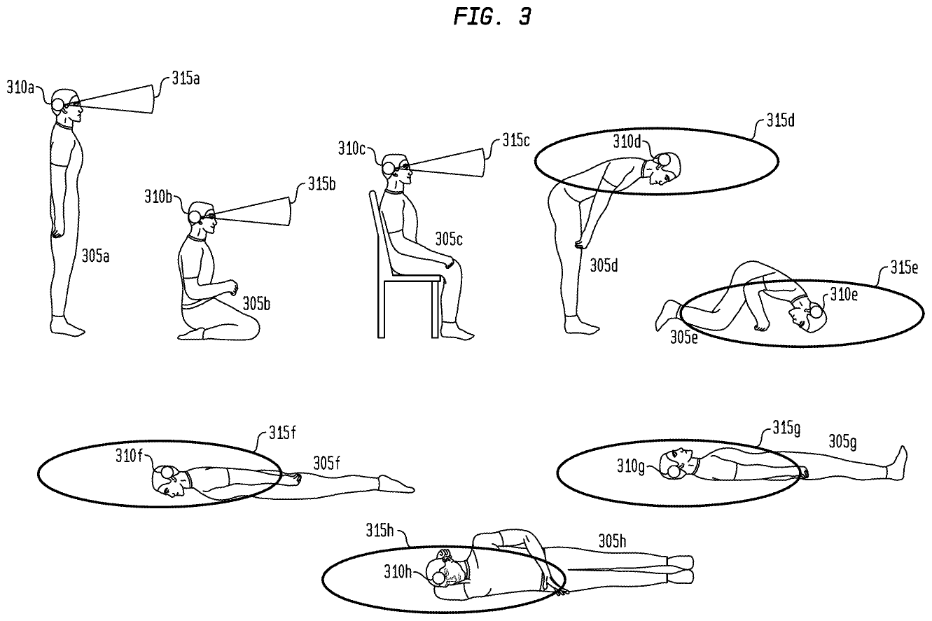

The techniques of the present disclosure, on the other hand, recognize recipient positions and/or posture and change microphone operating parameters to ensure appropriate operation of the microphone based on the recipient's body position or posture. For example, as illustrated in FIG. 3, recipients 305a-h exhibit different microphone directionality based upon their respective body posture and/or microphone orientation, according to the techniques of the present disclosure. For example, recipient 305a is in an upright position, and therefore, hearing device 310a exhibits directionality 315a in the direction in which recipient 305a is facing. Similarly, even though recipient 305b is in a kneeling position, and recipient 305c is in a sitting position, the hearing devices associated with these recipients, hearing devices 310b and 310c, respectively, both exhibit directionalities 315b and 315c in the directions in which recipients 305b and 305c are facing.

Recipients 305d-h, on the other hand, all have hearing devices 310d-h which exhibit omnidirectional operation 315d-h. For example, bending recipient 305d, crawling recipient 305e and prone recipient 305f are all facing the floor (i.e., the front of the recipients' faces are all directed toward the floor). Accordingly, the posture of these recipients is unlikely to be indicative of the location of the sounds that they intend to listen to. Therefore, if the directionality of hearing devices 310d-f were selected based upon where recipients 305d-f are facing, the processing of the audio signals received by hearing devices 310d-f may result in the elimination of the sound that recipients 305d-f intended to listen to. The same may be said for supine recipient 305g, who is facing the ceiling.

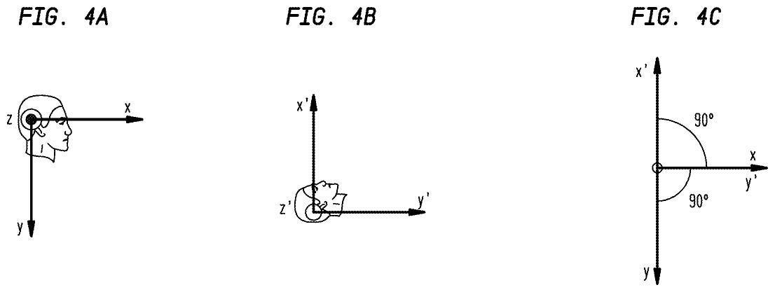

With respect to recipients 305d-g, the determination that the recipients may not be facing the source of the sound that they intend to listen to may be determined from the pitch of their hearing devices 310d-g relative to that of forward facing recipients 305a-c. Turning to FIG. 4A, for a forward facing recipient, the hearing device may define a coordinate system [x, y, z] such that the x-axis is oriented in the direction in which the recipient is looking, the y-axis is oriented downwards, and the z-axis is directed out of the page. The supine recipient of FIG. 4B, on the other hand, has a hearing device defining a coordinate system [x′, y′, z′] that is rotated 90° about the z-axis of the forward facing coordinate system of FIG. 4A, as illustrated in FIG. 4C. This represents a change in pitch of the hearing device of supine recipient 305g of FIG. 3 with respect to that of upright, forward facing recipient 305a, as well as to recipients 305b and 305c. Bowing recipient 305d, crawling recipient 305e and prone recipient 305f, all of FIG. 3, exhibit similar pitch changes relative to forward facing recipients 305a-c. Accordingly, the techniques of the present disclosure may implement changes to microphone directionality in response to recipient posture changes that result in a pitch change in the orientation of hearing devices. For example, if a hearing device undergoes a change in pitch beyond a certain threshold, the directionality of the microphones associated with the hearing device may change from a beamforming directional operation (as illustrated through recipients 305a-c) to an omnidirectional mode of operation (as illustrated through recipients 305d-g). According to one specific example embodiment, if the hearing device undergoes a change in pitch of greater than or equal to 90°, the directionality of the microphones associated with the hearing device may change from a beamforming directional operation to an omnidirectional mode of operation.

This threshold value may change or be updated in response to historical or contextual data associated with a particular recipient. For example, a particular recipient may consistently look down or up. Accordingly, the threshold that would trigger a change in directionality may be affected by such recipient-specific behavior.

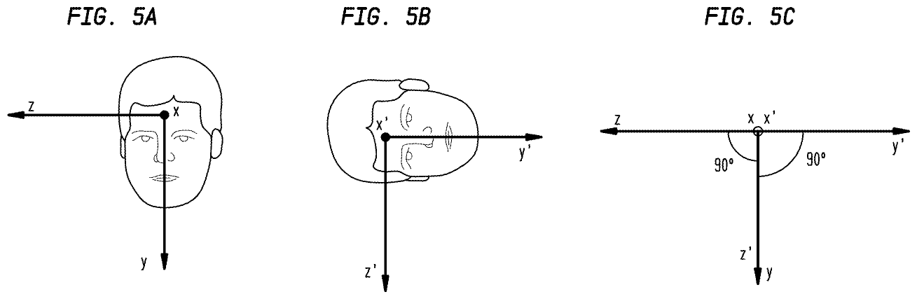

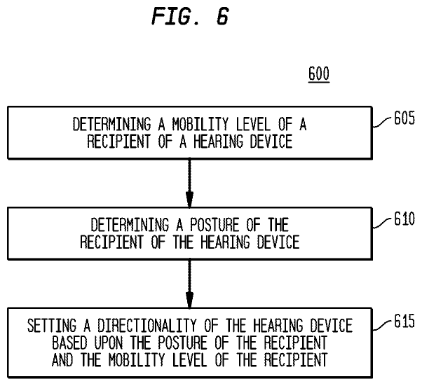

Returning to FIG. 3, with respect to recumbent recipient 305h, the determination that such recipients may not be facing the source of the sound that they intend to listen to may be determined from the roll of their hearing devices 310h relative to the hearing devices 310a-c of forward facing recipients 305a-c. Turning to FIG. 5A, for a forward facing recipient, the hearing device may define a coordinate system [x, y, z] such that the x-axis is oriented in the direction in which the recipient is looking, which in FIG. 5A would be out of the page. The y-axis is oriented downwards, and the z-axis is directed to the left as one looks at FIG. 5A. The recumbent recipient of FIG. 5B, on the other hand, has a hearing device defining a coordinate system [x′, y′, z′] that is rotated 90° about the x-axis of the forward facing coordinate system of FIG. 5A, as illustrated in FIG. 5C. This represents a change in roll of the hearing device 310h of recumbent recipient 305h with respect to that of upright, forward facing recipient 305a, as well as to recipients 305b and 305c, as illustrated in FIG. 3. Accordingly, the techniques of the present disclosure may implement changes to microphone directionality in response to recipient posture changes that result in a roll change in the orientation of hearing devices. For example, if a hearing device undergoes a change in roll beyond a certain threshold, the directionality of the microphones associated with the hearing device may change from a beamforming directional operation (as illustrated through recipients 305a-c) to an omnidirectional mode of operation (as illustrated through recipient 305h). For example, if the prosthesis undergoes a change in roll of greater than or equal to 90°, the directionality of the microphones associated with the hearing device may change from a beamforming directional operation to an omnidirectional mode of operation. As with the above-described threshold associated with changes in pitch, the threshold associated with changes in roll may change or be updated in response to historical or contextual data associated with a particular recipient.

For completion, it is noted that some hearing devices are configured such that their audio processing may only provide directional operation within the plane formed by the x and z coordinates of FIG. 5A (or the x′ and z′ coordinates of FIG. 5B). Accordingly, such hearing devices may be configured to change from a beamforming directional operation to an omnidirectional mode of operation (and vice versa) with this limitation as a consideration.

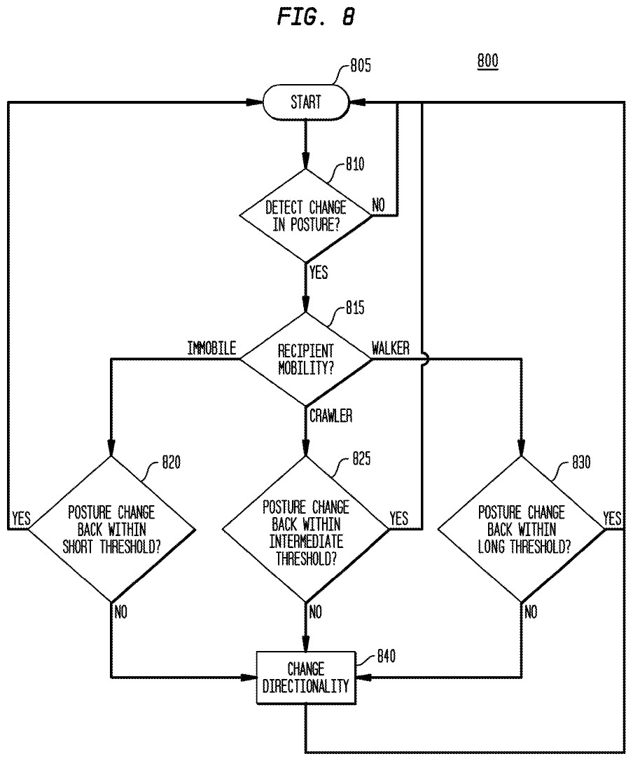

With reference now made to FIG. 6, depicted therein is a flowchart 600 illustrating a process flow for implementing the techniques of the present disclosure. Flowchart 600 begins in operation 605 where a mobility level of a recipient is determined. For example, operation 605 may include determining that the recipient of a hearing device is a pediatric recipient who is immobile, a crawler, or a walker. As explained in further detail below, the level of mobility of the pediatric recipients may affect the type of directionality under which the hearing device will operate. The level of mobility of the recipient may also affect the timing with which the directionality of hearing device is selected switched, or otherwise determined, as described in detail with reference to FIG. 8.

The determination of operation 605 may be based upon different factors and/or data depending on the specific example embodiment in which operation 605 is implemented. For example, hearing devices, such as the hearing device of operation 605, may undergo fitting operations by a provider, such as an audiologist, neurologist, or other healthcare provider, during which specific operating parameters and data are input and set. The fitting process may also include enabling and/or disabling certain features of the hearing device. During such a fitting process, data may be uploaded to the hearing device which indicates the mobility level of the recipient. This data may directly indicate the mobility level of the recipient through data that specifically indicates that the recipient is, for example, immobile, a crawler or a walker. The data may also indirectly indicate the mobility level of the recipient, such as indicating an age of the recipient.

The determination of operation 605 may also be based upon data acquired from the hearing device. For example, as described above with reference to FIGS. 1A-D, a hearing device may be configured with sensors, such as those incorporated into one or more of inertial measurement units 170 and 180 of FIG. 1D. As described above, inertial measurement units 170 and 180 may include accelerometers, gyroscopes, inclinometers, compasses, and the like. Based upon data acquired from these sensors, a mobility level for the recipient may be determined.

Next, in operation 610, the posture of the recipient is determined. For example, operation 610 may include determining that the recipient is in an upright position, a bowing or bent over position, a crawling position, a prone position, a supine position or a recumbent position, examples of which were discussed above with reference to FIG. 3. Operation 610 may also include distinguishing between positions where the recipient is sitting and facing forward, laying and facing forward, crawling and facing forward, standing and facing forward or walking and facing forward. For example, gyrometer data may indicate an orientation of the hearing device that indicates that the recipient is facing forward, while other data acquired concurrently from the inertial measurement unit may indicate whether the recipient is siting, laying, standing, walking or crawling. For example, certain patterns of accelerometer data may indicate that the recipient siting, laying, standing, walking or crawling while facing forward. More specifically, a walking recipient may exhibit head “wobble” that differs from that of a crawling, sitting or lying recipient.

Finally, in operation 615, a directionality of the hearing device is set based upon the posture of the recipient and the mobility level of the recipient. For example, the directionality of the hearing device may be switch from omnidirectional to beamforming operation, or vice versa, depending on the mobility level of the recipient and the posture of the recipient. If the recipient is immobile, and it is determined in operation 610 that the recipient is supine, the hearing device may be set to an omnidirectional mode of operation. On the other hand, if this same immobile recipient is determined to be in a sitting position, the operation of the hearing device may be set to a beamforming mode of operation. For example, when a young pediatric recipient, such as an infant, is set in a high chair, the hearing device may be set to a beamforming mode of operation as it may be assumed that the recipient will be facing and/or interacting with a parent. According to other example embodiments, an immobile recipient may receive omnidirectional operation of its hearing device when it is determined to be in a kneeling or crawling positions, while a crawling recipient may receive beamforming operation of its hearing device when in the same position. This difference in directionality operation may be based upon an assumption that the crawling recipient is more likely to be moving in the direction of the sound it intends to hear compared with an immobile recipient.

Accordingly, the method of flowchart 600 provides for a process in which the processor of a hearing device, such as a cochlear implant, recognizes the recipient posture (e.g., from prosthesis pitch or roll) and changes microphone sound path (e.g., beamforming vs. omnidirectional operation) to ensure the best possible SNR. The techniques of the present disclosure may use available technology in the sound processor (e.g., the above described inertial measurement units 170 and 180) to recognize hearing device orientation.

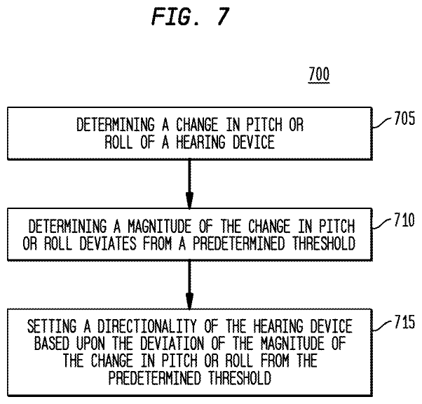

With reference now made to FIG. 7, depicted therein is a flowchart 700 illustrating a second example method for implementing the techniques of the present disclosure. The process flow of flowchart 700 begins in operation 705 where a change in pitch or roll of a hearing device is determined. For example, sensors included in a hearing device, such as those included in the inertial measurement unit 170 and/or the inertial measurement unit 180 of FIG. 1D, may be used to determine a change in pitch or roll of the hearing device.

In operation 710, a magnitude of the change in pitch or roll is determined to deviate from a predetermined threshold. For example, a magnitude of greater than or equal to 90° in the pitch or roll of the hearing device may result in a determination that the magnitude of the change in pitch or roll deviates from the predetermined threshold. According to specific example embodiments, the determination of operation 710 may include a determination that the recipient of a hearing device has changed his or her posture from one or more of the positions 305a-c of FIG. 3 to one of positions 305d-h of FIG. 3. Operation 710 may also include a determination that the recipient of a hearing device has changed his or her posture from one or more of the positions 305d-h of FIG. 3 to one of positions 305a-c of FIG. 3.

Finally, in operation 715, a directionality of the hearing device is set based on upon the deviation of the magnitude of the change in pitch or roll from the predetermined threshold. According to specific example embodiments, the setting of operation 715 may include a setting of the directionality from a beamforming mode of operation, as illustrated in directionalities 315a-c of FIG. 3, to an omnidirectional mode of operation, as illustrated in directionalities 315d-h of FIG. 3. According to other specific example embodiments, the setting of operation 715 may include a setting of the directionality from omnidirectional operation, as illustrated in directionalities 315d-h of FIG. 3, to a beamforming mode of operation, as illustrated in directionalities 315a-c of FIG. 3.

Example embodiments of the method of FIG. 7 may include more or fewer steps, as understood by the skilled artisan. For example, the method of FIG. 7 may include operations via which the predetermined threshold is determined. Specific example embodiments may include determining the predetermined threshold based upon data acquired by the hearing device, such as data acquired by one or more of inertial measurement unit 170 and/or inertial measurement unit 180 of FIG. 1D.

The techniques of the present disclosure, including the methods of FIGS. 6 and 7, may take into account processor orientation, as well as additional information, such as the age/birth date of the recipient, classifier results/records, beamformer results/records, data logging records, gyroscope logs, and/or relative sound level measurements between sound processor and implant microphones.

Specifically, the age and/or date of birth of the recipient may play into determining the mobility level of the recipient. For example, as explained above (and as explained with respect to different example embodiments below), the age of the recipient may dictate how the operation of the hearing device is altered in response to the detection of the posture of the recipient. Additionally, the age of the recipient may dictated other considerations, such as the speed with which the changes are made to the operational characteristics of the hearing device.

Classifier results/records may be used to determine the time and patterns for which a particular recipient remains upright. Accordingly, these classifier results and/or records may be used to determine the mobility level of a recipient. For example, if the recipient spends a significant amount of time upright, it may be determined that the recipient is a walker. On the other hand, if the recipient spends significant periods of time supine, it may be determined that the recipient is immobile, while a recipient that spends a significant amount of time prone may be determined to be a crawler.

Data logging records may be used to determine usage patterns of the recipients, allowing the hearing device to determine whether a particular posture is indicative of the recipient sleeping, walking or resting. For example, hearing device operation may be different depending on whether the recipient is sleeping or in a supine, prone or recumbent position for some other purpose. Data logging records may allow the processor of the hearing device to differentiate between a supine, prone or recumbent sleeping position or a supine, prone or recumbent non-sleeping position.

Similar to the classifier results/records, gyroscope logs may be used to determine time and patterns that a recipient has spent upright. Finally, the relative sound level measured between sound processor microphones and implant microphones may be used to the determine posture angle and patterns of posture.

As explained above, the speed of switching directionality modes of operation of a hearing device (e.g., the speed of switching between beamforming and omnidirectional modes of operation) may be based, a least partially, on the mobility of the recipient of the hearing device. According to specific examples, a pediatric recipient who is immobile (e.g., a relatively new born baby) may switch between directional and omnidirectional operation of the hearing device (and vice versa) more quickly than for a crawling or walking recipient. This is because an older recipient (e.g., a crawling or walking recipient) would be more aware of and in control of their posture. Accordingly, it may not be necessary to immediately switch from directional operation to omnidirectional operation when a change in posture of an older recipient is detected. Furthermore, a baby may benefit from fast or instant switching (not having the insight into what is going on with their hearing), while an adult may be irritated by such fast dynamics and prefer slower transitions.

For example, older recipients may be capable of bending over to pick up something off of the floor. It may not be beneficial to immediately switch from beamforming operation to omnidirectional operation in response to such a change in posture as the recipient may return to an upright posture very shortly. It could be distracting or otherwise detrimental to quickly switch back and forth between beamforming and omnidirectional operation in response to such short-lived posture changes. For an immobile recipient, such as a newborn baby, a change in posture is unlikely to be immediately or shortly followed by a return to the previous posture-a baby or other immobile recipient is incapable of changing posture on its own. Therefore, it may be beneficial to more quickly switch the directionality of the hearing devices for immobile recipients.

For recipients who fall between an immobile infant and a mobile adult, the switching time may be set as a compromise between the immobile and mobile settings. Furthermore, switching times may potentially even act as an incentive to stand more upright in order to improve hearing.

As now discussed with reference to FIG. 8, the switching times for changing the directionality of a hearing device may be dependent on the mobility of the recipient. While FIG. 8 illustrates the mobility based switching times in a separate flowchart 800, the mobility based switching time techniques of the present disclosure may be incorporated into, for example, the methods described above with reference to FIGS. 6 and 7.

As discussed with reference to the specific example embodiment of FIG. 8, immobile recipients may receive fast switching between beamforming and omnidirectional operation (and vice versa), crawling recipients may receive intermediate switching between beamforming and omnidirectional operation (and vice versa), and walking recipients may receive slow switching between beamforming and omnidirectional operation (and vice versa).

Flowchart 800 of FIG. 8 begins in operation 805 and proceeds to operation 810 where a change in posture is detected. Operation 810 may be embodied as the detection of a change in pitch or roll of a hearing device, such as a cochlear implant, that deviates from a predetermined threshold.

Upon detection of the change in posture of operation 810, a determination of the mobility of the recipient of the hearing device is determined. According to the specific example of operation 815, there are three options for the mobility of the recipient-an immobile recipient, a crawling recipient and a walking recipient. As illustrated in flowchart 800, the determination of the mobility level of the recipient of operation 815 is made after the detection of the change in posture in operation 810. As understood by the skilled artisan, the determination of the mobility of the recipient may be made prior to the detection of the posture change in operation 810, or even before the start 805 of flowchart 800.

Depending on the level of mobility of the recipient, the processing of flowchart 800 proceeds to one of operations 820, 825 or 830. Each of operations 820, 825 or 830 is a waiting period or time threshold within which the process of flowchart 800 waits to see if the posture of the recipient changes back to the posture prior to the posture change detected in operation 810. Operation 820, which is the operation for immobile recipients has the lowest time threshold. The threshold for operation 820 is relatively short because an immobile recipient is unlikely to revert to its previous posture.

Operation 825, which is the operation for crawling recipients, has an intermediate time threshold. The threshold for operation 825 is intermediate because a crawling recipient is more likely to revert to its previous posture than an immobile recipient, but less likely than a walking recipient.

Operation 830, which is the operation for walking recipients has a relatively long time threshold. The threshold for operation 830 is relatively long because a walking recipient is more likely to revert to its previous posture than both of an immobile recipient and a crawling recipient.

According to a specific example embodiment, the threshold for immobile recipients may be immediate or on the order of 0.5 to 1 seconds, the threshold for crawling recipients may be on the order of 1 to 1.5 seconds, and the threshold for walking recipients may be on the order of 1.5 seconds and greater. These values are just one example embodiment. Depending on the particular application and/or recipient, the time thresholds may be expanded, shorter or longer. Furthermore, there may be particular applications and/or recipients where the walking participants are given a shorter threshold than one or more of the immobile and crawling participants. Additionally, the threshold values are not exclusive, meaning there may be overlap of the time thresholds for the immobile, crawling and walking recipients.

In order to switch suitably fast between modes, a hysteresis curve may be used to determine the respective threshold times of operations 820, 825 and 830. The time thresholds of operations 820, 825 and 830 may be initially determined based on a simple lookup and weighting table and/or based on default settings of the hearing device processor. Additionally, the threshold values may be optimized as the hearing device is used by the recipient based on the recipient's usage and historical data, as well as the progressing age of the recipient. For example, machine learning may be used to optimize the thresholds of operations 820, 825 and 830.

As already noted, operations 820, 825 and 830 essentially pause the process flow of flowchart 800 in order to allow the recipient to revert its posture to that prior to the posture change detected in operation 810. If the recipient's posture does revert within the time period of operations 820, 825 and 830, then no change is made to the operation of the medical device, as the processing proceeds from operations 820, 825 and 830 back to the start 805. For example, if the posture prior to operation 810 is upright, a prone or supine posture is detected in operation 810, and the recipient's posture returns to an upright posture during the time threshold of operations 820, 825 or 830, then no change is made to the operation of the hearing device, as the processing of operations 820, 825 and 830 returns to start 805. Similarly, if the posture prior to operation 810 is prone or supine, an upright posture is detected in operation 810, and the recipient's posture returns to prone or supine during the time threshold of operations 820, 825 or 830, then no change is made to the operation of the hearing device, as the processing of operations 820, 825 and 830 returns to start 805.

On the other hand, if the recipients' posture does not change (i.e., does not revert to the posture prior to the change detected in operation 810), then the processing of operations 820, 825 and 830 proceeds to operation 840 which results in a change in the directionality of the operation of the hearing device. For example, if the posture prior to operation 810 is upright, the change detected in operation 810 is to a prone or supine posture, and the posture remains prone or supine through the time threshold of operations 820, 825 or 830, then the directionality of the hearing device may be changed from beamforming operation to omnidirectional operation in operation 840. Similarly, if the posture prior to operation 810 is prone or supine, the change detected in operation 810 is to an upright posture, and the posture remains upright through the time threshold of operations 820, 825 or 830, then the directionality of the hearing device is changed from omnidirectional operational to beamforming operation in operation 840.

Once the directionality of the hearing device is changed in operation 840, the processing of flowchart 800 returns to start 805 to await another posture change.

In addition to the features described above with reference to FIGS. 2A, 2B and 3-8, the techniques of the present disclosure may be used to drive the functionality of additional features of hearing devices. As described below, these additional features may include monitoring software or other medical device indicators that communicate to clinicians how the techniques of the present disclosure are being implemented for a particular recipient. For example, clinicians may be reluctant to implement directionality features of hearing devices for pediatric recipients as pediatric recipients may have difficulty communicating to the clinician if the directionality features are working properly or working in a way that is beneficial. To use the example of an infant or another non-verbal recipient, such recipients may be incapable of communicating to clinicians when and how the features are being implemented-an infant cannot communicate to a clinician that omnidirectional operation is used when the infant is in a prone or supine posture, but directional operation is being used when in an upright posture. To accommodate such clinician concerns, the techniques of the of the present disclosure also provide for additional functionality that communicates to clinicians how the techniques of the present application are being implemented for a recipient.

For example, the techniques of the present disclosure may be used in conjunction with software or an “app” running on a personal computer, smartphone, tablet or other processing device. Data communicated to such software via the hearing device may allow clinicians to ensure that the techniques of the present disclosure are being appropriately implemented. For example, the software or app may communicate with the hearing device to display both the detected posture for the recipient and the current mode of operation (e.g., beamforming vs. omnidirectional operation) for the recipient. The clinician may then use these indications to confirm that they are internally consistent (i.e., beamforming operation is used when the recipient is upright, omnidirectional operation is used when the recipient is prone, supine or recumbent), and also to confirm that the data displayed in the software or app matches the actual posture of the recipient.

Additional indicators may also be incorporated into the external components of hearing devices, such as external component 104 or external device 110 of FIG. 1D. For example, a light emitting diode (LED) may be incorporated in such external components. The LED may be driven such that when the hearing device is operating in a particular mode, such as a beamforming mode, the LED is on. The visual indication provided by the LED may be used by clinicians or parents of pediatric recipients to confirm that the techniques of the present disclosure are being appropriately implemented in the hearing device.

Data logging may also be used to ensure that the techniques of the present disclosure are being appropriately implemented for recipients. For example, the processors associated with hearing devices may track the detected posture and corresponding operation of the hearing device to ensure that when the detected posture is upright, the operation of the hearing device is directional, and that when the detected posture is prone, supine or recumbent, the operation of the hearing device is omnidirectional.

The hearing devices implementing the techniques of the present disclosure may also include features that allow users to enable or disable to the features and/or force a particular mode of operation that would otherwise be contrary to the detected posture. For example, a physical or software switch may be implemented in the hearing device or accompanying app to lock a particular mode of operation regardless of the detected posture of the recipient. Specifically, a particular recipient or parent of a pediatric recipient may lock the operation of the hearing device in beamforming operation if, for example, it is known that the recipient will be in a prone/supine/recumbent position but nevertheless facing in the direction of the intended audio source. Similarly, there may be situations where a recipient will be in an upright position, but omnidirectional operation will be the preferred mode. Therefore, a recipient may be provided with a hardware or software switch that locks omnidirectional operation regardless of the recipient's posture.

Finally, while the above description focuses on the directionality of a hearing device, the techniques of the present disclosure may be implemented to affect other operational features of hearing devices based on a detected posture of a recipient. For example, the techniques of the present disclosure may be used to implement changes in feedback cancellation parameters in response to changes in posture. The techniques of the present disclosure may also be used to alter or customize other signal processing parameters in response to changes in posture, including adjustment to wind noise cancellation processing, scene classifier processing, and the enabling and disabling of physical buttons on the hearing devices. For example, certain postures and/or posture changes may be indicative of certain activities or locations, which may be considerations in wind noise cancellation processing. Similarly, some hearing devices are configured to adapt sound processing to a particular environment or “scene.” For example, some hearing devices are configured to analyze recipient surroundings, identify the listening environment, and automatically optimize sound processing for the identified surrounding or scene. Certain postures and/or posture changes may be indicative of certain surroundings or of certain scenes. Therefore, the techniques presented herein may be included in such sound classifier processing techniques. Finally, certain postures and/or posture changes may indicate that a recipient is participating in physical activity that could cause buttons or other hearing device controls to be inadvertently activated. The techniques presented herein may be used to identify such physical activity (or lack of such physical activity) and enable or disable buttons or controls on the hearing device accordingly.

As discussed above, the techniques of the present disclosure may be particularly beneficial and/or applicable to pediatric recipients. Specifically, the techniques of the present disclosure may enable clinicians to confidently permit hearing devices processors to make decisions on directionality rather than leaving directionality out altogether for pediatric recipients. Other recipient groups may also benefit from the techniques of the present disclosure, including bedridden recipients, otherwise immobile recipients, or recipients who simply spend little time in upright postures. The techniques of the present disclosure may also be particularly applicable to recipients whose processors may not sit neatly on the pinna but on the chest or even on a bedside table. Healthy, upright and walking adult recipients may still benefit from the techniques of the present disclosure when bending down occasionally (e.g., when doing housework) or habitually (e.g., when gardening).

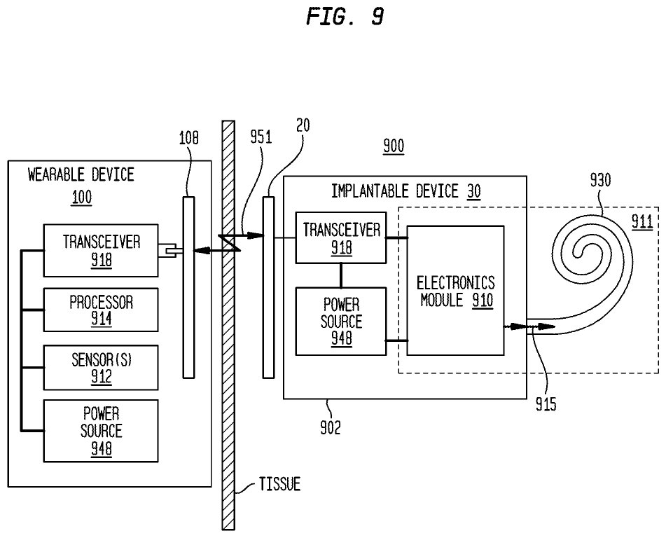

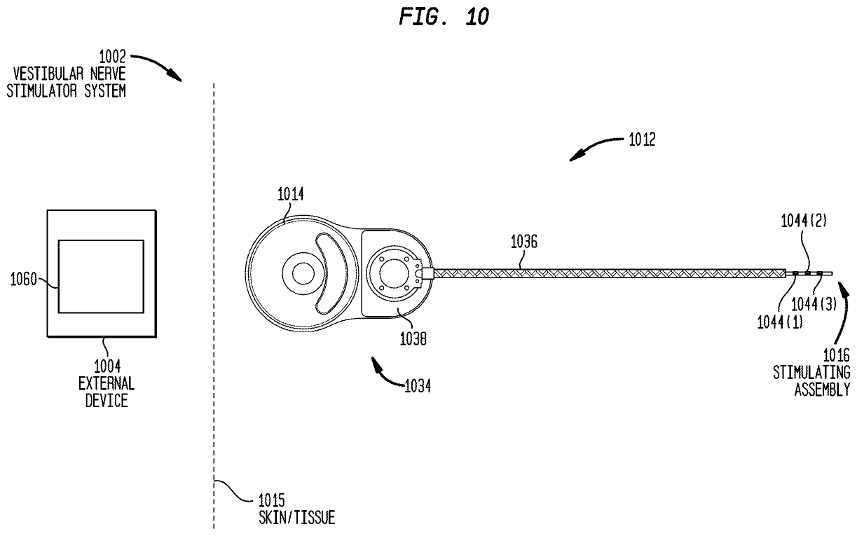

As previously described, the technology disclosed herein can be applied in any of a variety of circumstances and with a variety of different devices. Example devices that can benefit from technology disclosed herein are described in more detail in FIGS. 9 and 10, below. As described below, the operating parameters for the devices described with reference to FIGS. 9 and 10 may be configured according to the techniques described herein. The techniques of the present disclosure can be applied to other medical devices, such as neurostimulators, cardiac pacemakers, cardiac defibrillators, sleep apnea management stimulators, seizure therapy stimulators, tinnitus management stimulators, and vestibular stimulation devices, as well as other medical devices that deliver stimulation to tissue, to the extent that the operating parameters of such devices may be tailored based upon the posture of the recipient receiving the device. Further, technology described herein can also be applied to consumer devices. These different systems and devices can benefit from the technology described herein. For example, the posture-based operation techniques of the present disclosure may be applied to consumer grade or commercial grade headphone or ear bud products.

FIG. 9 is a functional block diagram of an implantable stimulator system 900 that can benefit from the technologies described herein. The implantable stimulator system 900 includes the wearable device 100 acting as an external processor device and an implantable device 30 acting as an implanted stimulator device. In examples, the implantable device 30 is an implantable stimulator device configured to be implanted beneath a recipient's tissue (e.g., skin). In examples, the implantable device 30 includes a biocompatible implantable housing 902. Here, the wearable device 100 is configured to transcutaneously couple with the implantable device 30 via a wireless connection to provide additional functionality to the implantable device 30.

In the illustrated example, the wearable device 100 includes one or more sensors 912, a processor 914, a transceiver 918, and a power source 948. The one or more sensors 912 can be one or more units configured to produce data based on sensed activities. In an example where the stimulation system 900 is an auditory prosthesis system, the one or more sensors 912 include sound input sensors, such as a microphone, an electrical input for an FM hearing system, other components for receiving sound input, or combinations thereof. Where the stimulation system 900 is a visual prosthesis system, the one or more sensors 912 can include one or more cameras or other visual sensors. Where the stimulation system 900 is a cardiac stimulator, the one or more sensors 912 can include cardiac monitors. The processor 914 can be a component (e.g., a central processing unit) configured to control stimulation provided by the implantable device 30. The stimulation can be controlled based on data from the sensor 912, a stimulation schedule, or other data. Where the stimulation system 900 is an auditory prosthesis, the processor 914 can be configured to convert sound signals received from the sensor(s) 912 (e.g., acting as a sound input unit) into signals 951. The transceiver 918 is configured to send the signals 951 in the form of power signals, data signals, combinations thereof (e.g., by interleaving the signals), or other signals. The transceiver 918 can also be configured to receive power or data. Stimulation signals can be generated by the processor 914 and transmitted, using the transceiver 918, to the implantable device 30 for use in providing stimulation. Processor 914 may also include an inertial measurement unit analogous to inertial measurement unit 170 of FIG. 1D.

In the illustrated example, the implantable device 30 includes a transceiver 918, a power source 948, and a medical instrument 911 that includes an electronics module 910 and a stimulator assembly 930. The implantable device 30 further includes a hermetically sealed, biocompatible implantable housing 902 enclosing one or more of the components.

The electronics module 910 can include one or more other components to provide medical device functionality. In many examples, the electronics module 910 includes one or more components for receiving a signal and converting the signal into the stimulation signal 915. The electronics module 910 can further include a stimulator unit. The electronics module 910 can generate or control delivery of the stimulation signals 915 to the stimulator assembly 930. In examples, the electronics module 910 includes one or more processors (e.g., central processing units or microcontrollers) coupled to memory components (e.g., flash memory) storing instructions that when executed cause performance of an operation. In examples, the electronics module 910 generates and monitors parameters associated with generating and delivering the stimulus (e.g., output voltage, output current, or line impedance). In examples, the electronics module 910 generates a telemetry signal (e.g., a data signal) that includes telemetry data. The electronics module 910 can send the telemetry signal to the wearable device 100 or store the telemetry signal in memory for later use or retrieval. Electronics module 910 may also include an inertial measurement unit analogous to inertial measurement unit 180 of FIG. 1D. The stimulator assembly 930 can be a component configured to provide stimulation to target tissue. In the illustrated example, the stimulator assembly 930 is an electrode assembly that includes an array of electrode contacts disposed on a lead. The lead can be disposed proximate tissue to be stimulated. Where the system 900 is a cochlear implant system, the stimulator assembly 930 can be inserted into the recipient's cochlea. The stimulator assembly 930 can be configured to deliver stimulation signals 915 (e.g., electrical stimulation signals) generated by the electronics module 910 to the cochlea to cause the recipient to experience a hearing percept. In other examples, the stimulator assembly 930 is a vibratory actuator disposed inside or outside of a housing of the implantable device 30 and configured to generate vibrations. The vibratory actuator receives the stimulation signals 915 and, based thereon, generates a mechanical output force in the form of vibrations. The actuator can deliver the vibrations to the skull of the recipient in a manner that produces motion or vibration of the recipient's skull, thereby causing a hearing percept by activating the hair cells in the recipient's cochlea via cochlea fluid motion.

The transceivers 918 can be components configured to transcutaneously receive and/or transmit a signal 951 (e.g., a power signal and/or a data signal). The transceiver 918 can be a collection of one or more components that form part of a transcutaneous energy or data transfer system to transfer the signal 951 between the wearable device 100 and the implantable device 30. Various types of signal transfer, such as electromagnetic, capacitive, and inductive transfer, can be used to usably receive or transmit the signal 951. The transceiver 918 can include or be electrically connected to a coil 20.

As illustrated, the wearable device 100 includes a coil 108 for transcutaneous transfer of signals with the concave coil 20. As noted above, the transcutaneous transfer of signals between coil 108 and the coil 20 can include the transfer of power and/or data from the coil 108 to the coil 20 and/or the transfer of data from coil 20 to the coil 108. The power source 948 can be one or more components configured to provide operational power to other components. The power source 948 can be or include one or more rechargeable batteries. Power for the batteries can be received from a source and stored in the battery. The power can then be distributed to the other components as needed for operation.

As should be appreciated, while particular components are described in conjunction with FIG. 9, technology disclosed herein can be applied in any of a variety of circumstances. The above discussion is not meant to suggest that the disclosed techniques are only suitable for implementation within systems akin to that illustrated in and described with respect to FIG. 9. In general, additional configurations can be used to practice the methods and systems herein and/or some aspects described can be excluded without departing from the methods and systems disclosed herein.

FIG. 10 illustrates an example vestibular stimulator system 1002, with which embodiments presented herein can be implemented. As shown, the vestibular stimulator system 1002 comprises an implantable component (vestibular stimulator) 1012 and an external device/component 1004 (e.g., external processing device, battery charger, remote control, etc.). The external device 1004 comprises a transceiver unit 1060. As such, the external device 1004 is configured to transfer data (and potentially power) to the vestibular stimulator 1012. External device 1004 may also include an inertial measurement unit analogous to inertial measurement unit 170 of FIG. 1D.

The vestibular stimulator 1012 comprises an implant body (main module) 1034, a lead region 1036, and a stimulating assembly 1016, all configured to be implanted under the skin/tissue (tissue) 1015 of the recipient. The implant body 1034 generally comprises a hermetically-sealed housing 1038 in which RF interface circuitry, one or more rechargeable batteries, one or more processors, and a stimulator unit are disposed. The implant body 1034 also includes an internal/implantable coil 1014 that is generally external to the housing 1038, but which is connected to the transceiver via a hermetic feedthrough (not shown). Implant body 1034 may also include an inertial measurement unit analogous to inertial measurement unit 180 of FIG. 1D.

The stimulating assembly 1016 comprises a plurality of electrodes 1044(1)-(3) disposed in a carrier member (e.g., a flexible silicone body). In this specific example, the stimulating assembly 1016 comprises three (3) stimulation electrodes, referred to as stimulation electrodes 1044(1), 1044(2), and 1044(3). The stimulation electrodes 1044(1), 1044(2), and 1044(3) function as an electrical interface for delivery of electrical stimulation signals to the recipient's vestibular system.

The stimulating assembly 1016 is configured such that a surgeon can implant the stimulating assembly adjacent the recipient's otolith organs via, for example, the recipient's oval window. It is to be appreciated that this specific embodiment with three stimulation electrodes is merely illustrative and that the techniques presented herein may be used with stimulating assemblies having different numbers of stimulation electrodes, stimulating assemblies having different lengths, etc.

In operation, the vestibular stimulator 1012, the external device 1004, and/or another external device, can be configured to implement the techniques presented herein. That is, the vestibular stimulator 1012, possibly in combination with the external device 1004 and/or another external device, can include an evoked biological response analysis system, as described elsewhere herein.

As should be appreciated, while particular uses of the technology have been illustrated and discussed above, the disclosed technology can be used with a variety of devices in accordance with many examples of the technology. The above discussion is not meant to suggest that the disclosed technology is only suitable for implementation within systems akin to that illustrated in the figures. In general, additional configurations can be used to practice the processes and systems herein and/or some aspects described can be excluded without departing from the processes and systems disclosed herein.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., portions, components, etc.) described with respect to the figures herein are not intended to limit the systems and processes to the particular aspects described. Accordingly, additional configurations can be used to practice the methods and systems herein and/or some aspects described can be excluded without departing from the methods and systems disclosed herein.

According to certain aspects, systems and non-transitory computer readable storage media are provided. The systems are configured with hardware configured to execute operations analogous to the methods of the present disclosure. The one or more non-transitory computer readable storage media comprise instructions that, when executed by one or more processors, cause the one or more processors to execute operations analogous to the methods of the present disclosure.

Similarly, where steps of a process are disclosed, those steps are described for purposes of illustrating the present methods and systems and are not intended to limit the disclosure to a particular sequence of steps. For example, the steps can be performed in differing order, two or more steps can be performed concurrently, additional steps can be performed, and disclosed steps can be excluded without departing from the present disclosure. Further, the disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

It is also to be appreciated that the embodiments presented herein are not mutually exclusive and that the various embodiments may be combined with another in any of a number of different manners.

1. A method, comprising:
determining a mobility level of a recipient of a hearing device;
determining a posture of the recipient of the hearing device; and
setting a directionality of the hearing device based upon the posture of the recipient and the mobility level of the recipient.

2. The method of claim 1, wherein determining the mobility level of the recipient comprises:
determining the recipient is a pediatric recipient.

3. The method of claim 1, wherein determining the mobility level of the recipient comprises:
determining the recipient is immobile.

4. The method of claim 1, wherein determining the mobility level of the recipient comprises:
determining that the recipient crawls.

5. The method of claim 1, wherein determining the mobility level of the recipient comprises:
determining the recipient walks.

6. The method of claim 1, wherein determining the mobility level of the recipient comprises:
receiving data indicative of the mobility level of the recipient.

7. The method of claim 1, wherein determining the mobility level of the recipient and determining the posture of the recipient comprises:
evaluating sensor data received from one or more sensors included in the hearing device.

8. The method of claim 7, wherein the sensor data comprises one or more of:
accelerometer data;
inclinometer data;
gyrometer data; or
compass data.

9. The method of claim 1, wherein determining the posture of the recipient of the hearing device comprises:
determining a change in pitch of an orientation of the hearing device.

10. (canceled)

11. (canceled)

12. The method of claim 1, wherein setting the directionality of the hearing device comprises:
changing the directionality of the hearing device from a first directionality to a second directionality, wherein the first directionality comprises one of a beamforming directionality or an omnidirectionality, and wherein the second directionality comprises another of the beamforming directionality or the omnidirectionality.

13. The method of claim 1, further comprising:
determining contextual data associated with the recipient, wherein setting the directionality of the hearing device comprises setting the directionality based on the contextual data.

14. The method of claim 13, wherein the contextual data comprises one or more of:
age data for the recipient;
historical posture data for the recipient;
historical directionality setting data for the hearing device;
behavior data for the recipient; and
historical signal processing data for the hearing device.

15. The method of claim 1, further comprising:
waiting a predetermined time period between determining the posture of the recipient of the hearing device and setting the directionality of the hearing device; and
determining that the posture of the recipient of the hearing device does not change within the predetermined time period,
wherein setting the directionality of the hearing device comprises setting the directionality of the hearing device in response to determining that the posture of the recipient of the hearing device does not change within the predetermined time period.

16. The method of claim 15, further comprising:
determining the predetermined time period based upon the mobility level of the recipient.

17. One or more non-transitory computer readable storage media comprising instructions that, when executed by a processor, cause the processor to:
determine a change in pitch or roll of a hearing device;
determine magnitude of the change in pitch or roll deviates from a predetermined threshold; and
set a directionality of the hearing device based upon a deviation of the magnitude of the change in pitch or roll from the predetermined threshold.

18. The non-transitory computer readable storage media of claim 17, wherein the predetermined threshold comprises a value less than 90 degrees, and wherein the instructions operable to determine the magnitude of the change in pitch or roll deviates from the predetermined threshold comprise instructions operable to:
determine that the magnitude of the change in pitch or roll is greater than or equal to 90 degrees.

19. The non-transitory computer readable storage media of claim 18, further comprising instructions operable to:
determine the predetermined threshold from data specific to a recipient of the hearing device, wherein the data specific to the recipient of the hearing device comprises:
historical accelerometer data associated with the hearing device;
historical inclinometer data associated with the hearing device;
historical gyrometer data associated with the hearing device; or
historical compass data associated with the hearing device.

20. (canceled)

21. The non-transitory computer readable storage media of claim 17, wherein the instructions operable to set the directionality of the hearing device comprises:
changing the directionality of the hearing device from a first directionality to a second directionality, wherein the first directionality comprises one of a beamforming directionality or an omnidirectionality, and wherein the second directionality comprises another of the beamforming directionality or the omnidirectionality.

22. The non-transitory computer readable storage media of claim 17, further comprising instructions operable to:
wait a predetermined time period between determining the change in pitch or roll of the hearing device and setting the directionality of the hearing device; and
determine that the pitch or roll of the hearing device does not change within the predetermined time period,
wherein the instructions operable to set the directionality of the hearing device comprise instructions operable to set the directionality of the hearing device in response to determining that the pitch or roll of the hearing device of the hearing device does not change within the predetermined time period.

23. The non-transitory computer readable storage media of claim 22, further comprising instructions operable to:
determine the predetermined time period based upon a mobility level of a recipient of the hearing device.

24. A hearing device comprising:
one or more inertial sensors;
one or more microphones; and
one or more processors, wherein the one or more processors are configured to:
determine a mobility level of a recipient of the hearing device;
determine a posture of the recipient of the hearing device from data received from the one or more inertial sensors; and
process audio signals received from the one or more microphones according to a directionality based upon the posture of the recipient and the mobility level of the recipient.

25. The hearing device of claim 24, wherein the one or more processors are configured to determine the mobility level of the recipient by determining the recipient is a pediatric recipient.

26. The hearing device of claim 24, wherein the one or more processors are configured to determine the mobility level of the recipient by determining the recipient is immobile.

27. The hearing device of claim 24, wherein the one or more processors are configured to determine the mobility level of the recipient by determining the recipient crawls.

28. The hearing device of claim 24, wherein the one or more processors are configured to determine the mobility level of the recipient by determining the recipient walks.

29. (canceled)

30. (canceled)

31. The hearing device of claim 24, wherein the one or more processors are configured to determine the posture of the recipient of the hearing device by determining a change in pitch or roll of an orientation of the hearing device.

32. The hearing device of claim 24, wherein the one or more processors are configured to determine the posture of the recipient of the hearing device by evaluating data received from the one or more inertial sensors.

33. The hearing device of claim 24, wherein the one or more processors are configured to process the audio signals received from the one or more microphones by changing the processing of the audio signals from a first directionality to a second directionality, wherein the first directionality comprises one of a beamforming directionality or an omnidirectionality, and wherein the second directionality comprises another of the beamforming directionality or the omnidirectionality.

34. The hearing device of claim 24, wherein the one or more processors are configured to receive contextual data associated with the recipient, and process the audio signals received from the one or more microphones according to a directionality based on the contextual data, and wherein the contextual data comprises:
age data for the recipient;
historical posture data for the recipient;
historical directionality setting data for the hearing device;
behavior data for the recipient; and
historical signal processing data for the hearing device.

35. (canceled)

36. (canceled)
